(19) United States
(12) Patent Application Publication
(10) Pub. No.: US 2025/0304095 A1
(43) Pub. Date: Oct. 2, 2025

(54) VISUAL INDICATOR FOR OPTIMAL ACCELERATION DETERMINED BY MACHINE LEARNING MODEL TRAINED ON LIVE PHONE AND VEHICLE DATA

(71) Applicant: Kristofer ZIEB, Pacifica, CA (US)

(72) Inventor: Kristofer ZIEB, Pacifica, CA (US)

(21) Appl. No.: 19/089,410

(22) Filed: Mar. 25, 2025

Related U.S. Application Data
(60) Provisional application No. 63/570,433, filed on Mar. 27, 2024.

(51) Int. Cl. B60W 50/14; B60K 35/28

(52) U.S. Cl. CPC B60W 50/14; B60K 35/28; B60K 2360/174; B60K 2360/188; B60K 2360/566; B60K 2360/592; B60W 2050/146; B60W 2520/105; B60W 2556/45

(57) ABSTRACT

Methods and systems for determining optimal acceleration and related indication may be provided. A machine learning (ML) and/or artificial intelligence (AI) model may be trained using a plurality of acceleration and fuel efficiency data. The ML or AI model may be used to determine whether a given driver's driving behavior, for example acceleration and deceleration, are fuel efficient. In some embodiments an indicator may notify the driver of whether their driving behavior is fuel efficient and/or may indicate how the driving may be more fuel efficient.

### BACKGROUND

As climate change continues to evolve easy consumer friendly ways of having a positive environmental impact are increasingly important. Additionally, 92% of households own a vehicle. In 2021, Americans burned through 369 million gallons of gas per day; and electric vehicles only saved the U.S. the equivalent of two days' worth of gasoline that same year. Department of Energy research has shown that optimal driving can improve fuel economy up to 30% on the highway and 40% in stop-and-go traffic, making this enormously beneficial to the average consumer, and even more so for the estimated 1.7 million rideshare drivers in the US today. However, many lack the tools and knowledge to make the necessary changes in their driving habits.

### SUMMARY

In an exemplary embodiment, a method for determining optimal acceleration and related indication may be provided. A machine learning (ML) and/or artificial intelligence (AI) model may be trained using a plurality of acceleration and fuel efficiency data. The ML or AI model may be used to determine whether a given driver's driving behavior, for example acceleration and deceleration, are fuel efficient. In some embodiments an indicator may notify the driver of whether their driving behavior is fuel efficient and/or may indicate how the driving may be more fuel efficient.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary simple data flow pipeline for determining optimal acceleration.

FIG. 2 shows an exemplary refined data flow pipe for determining optimal acceleration.

FIG. 3A shows an exemplary first indication simple acceleration response indicator.

FIG. 3B shows an exemplary second indication simple acceleration response indicator.

FIG. 4A shows an exemplary first indication refined acceleration response indicator.

FIG. 4B shows an exemplary second indication refined acceleration response indicator.

FIG. 4C shows an exemplary third indication refined acceleration response indicator.

FIG. 5 shows an exemplary decision tree.

FIG. 6 shows an exemplary trained model flowchart.

FIG. 7 shows another exemplary trained model flowchart.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Large Language Models (LLMs), transformers, decision trees, random forests, expert systems, mixture of experts models, ensemble models, diffusion models, and autoencoder models, to name a few. However, many other forms of AI and ML architectures that enable the processor to perform the same functionality have been considered.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

In one or more exemplary embodiments methods and systems for determining optimal acceleration may be provided.

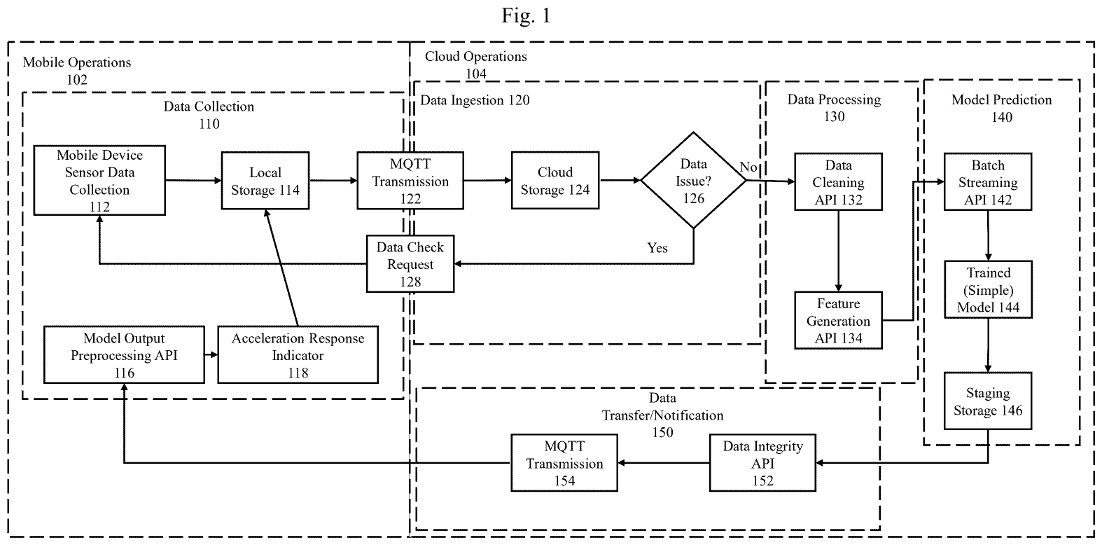

Referring to FIG. 1 an exemplary simple data flow pipeline 100 for determining optimal acceleration may be shown and described. The simple data flow pipeline 100 may include both mobile operations 102 which may be carried out by a computing device such as a mobile phone, and cloud operations 104 which may be carried out by a cloud computing network or service. The data flow pipeline 100 may include data collection steps 110, data ingestion steps 120, data processing steps 130, model prediction steps 140, and data transfer or notification steps 150. In an exemplary embodiment the data collection steps 110 may be carried out by the mobile operations 102 and the data ingestion steps 120, the data processing steps 130, the model prediction steps 140, and the data transfer or notification steps 150 may be carried out by the cloud operations 104.

In an exemplary embodiment the data collection steps 110 may include mobile device sensor data 112, which may be data collected by a computing device such as, for example, a mobile device. The data may include, for example, acceleration data taken from an accelerometer and angular velocity data taken from a gyroscope. The mobile device sensor data 112 may be sent to a local storage 114. The local storage 114 may further be used for error logging and batching data before sending. Additionally, a model output preprocessing API 116 may send previously collected and generated model data to an acceleration response indicator 118, which may be stored in local storage 114. The model output preprocessing API 116 may take data from values output from the ML model, for example a binary value indicating optimality of driver acceleration for peak fuel efficiency and may add metadata such as timestamps or ID strings. In some embodiments batches of data may be ordered then sent to a response indicator, which may ensure a “first-in, first-out” data flow.

The acceleration response indicator 118 may be a visual display that informs a user of the quality of acceleration or other driving patterns with respect to fuel efficiency. In some embodiments the acceleration response indicator 118 may return a Boolean true/false output, while in other embodiments a numeric value (for example between 0 and 1) may be returned, where a higher number may indicate more optimal driving patterns. The acceleration response indicator 118 output may further be stored to be used as an additional input into the ML model, which may allow for a feedback feature.

In an exemplary embodiment the data ingestion steps 120 may include data being sent via MQTT transmission 122 from the local storage 114 to a cloud storage 124. Data issues 126 may then be checked, for example it may be ensured the data was properly received by the mobile sender. If data issues are detected then a data check request 128 may be sent to the mobile device for additional mobile device sensor data 112. If no data issue 126 is found then the data may be sent to the data processing steps 130, and the data may be cleaned by a data cleaning API 132 which may check data integrity and add imputation values as needed. A feature generation API 134 may then add additional features beyond the directly fed data including, but not limited to, first and second derivatives of acceleration, velocity, first and second derivatives of angular velocity, and statistical aggregates over different time windows, etc.

In an exemplary embodiment the model prediction steps 140 may include sending the data to a batch streaming API 142, which may handle streaming data to a ML model hosted on the cloud. The trained model 144 may then receive as input the data streamed from batch streaming API 142. The trained model 144 may then output binary classification values, for example a 1 or a 0 corresponding to optimal or suboptimal acceleration respectively, to be stored in a staging storage 146.

In an exemplary embodiment the data transfer and notifications steps 150 may include running the output of the trained model 144 through a data integrity API 152. After going through the data integrity API 152 the data may be transmitted via MQTT Transmission 154 to the model output preprocessing API 116.

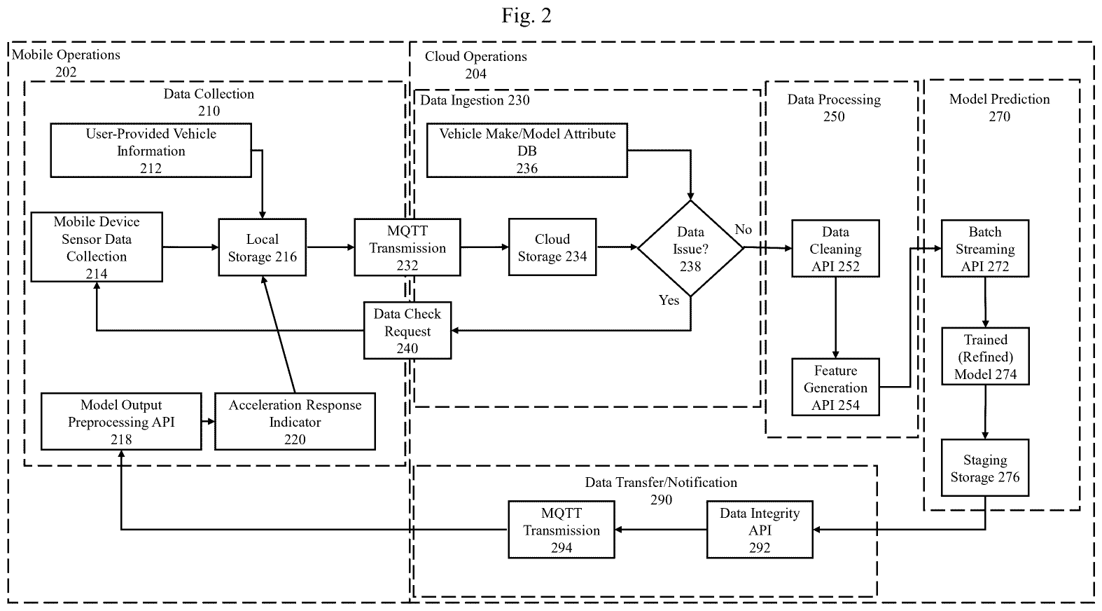

Referring to FIG. 2 an exemplary refined data flow pipe 200 for determining optimal acceleration may be shown and described. The refined data flow pipeline 200 may include both mobile operations 202 which may be carried out by a computing device such as a mobile phone, and cloud operations 204 which may be carried out by a cloud computing network or service. The data flow pipeline 200 may include data collection steps 210, data ingestion steps 230, data processing steps 250, model prediction steps 270, and data transfer or notification steps 290. In an exemplary embodiment the data collection steps 210 may be carried out by the mobile operations 202 and the data ingestion steps 230, the data processing steps 250, the model prediction steps 270, and the data transfer or notification steps 290 may be carried out by the cloud operations 204.

In an exemplary embodiment the data collection steps 210 may include vehicle information 212 and mobile device sensor data 214, which may be data collected by a mobile device, being fed into a local storage 216. The vehicle information 212 may be user provided or obtained by any other means, and may include, for example but not limited to, vehicle year, vehicle make, and vehicle model. Additionally, a model output preprocessing API 218 may send previously collected and generated model output data to an acceleration response indicator 220, which may be stored in local storage 216.

In an exemplary embodiment the data ingestion steps 230 may include data being sent via MQTT transmission 232 from the local storage 216 to a cloud storage 234. Vehicle make and model attribute data may also be fed in via a vehicle make and model attribute database 236. The vehicle make and model attribute database 236 may include, for example but not limited to, a list of vehicles by year, make, and model, and associated data including but not limited to, 0-60 mph acceleration time, engine volume, cylinder count, and vehicle horsepower. Data issues 238 may then be checked, if data issues are detected then a data check request 240 may be sent to the mobile device for additional mobile device sensor data 214. If no data issue 238 is found then the data may be sent to the data processing steps 250, and the data may be cleaned by a data cleaning API 252 which may check data integrity and add imputation values as needed. A feature generation API 254 may then add additional features beyond the directly fed data including, but not limited to, first and second derivatives of acceleration, velocity, first and second derivatives of angular velocity, and statistical aggregates over different time windows, etc.

In an exemplary embodiment the model prediction steps 270 may include sending the data to a batch streaming API 272 which may handle streaming data to a ML model hosted on the cloud. The trained model 274 may then receive as input the data streamed from batch streaming API 272. The trained model 274 may then output continuous regression values, for example the range of values between 0 and 1 corresponding to the degree of optimality of acceleration, to be stored in a staging storage 276.

In an exemplary embodiment the data transfer and notifications steps 290 may include running the output of the trained model 274 through a data integrity API 292. After going through the data integrity API 292 the data may be transmitted via MQTT Transmission 294 to the model output preprocessing API 218.

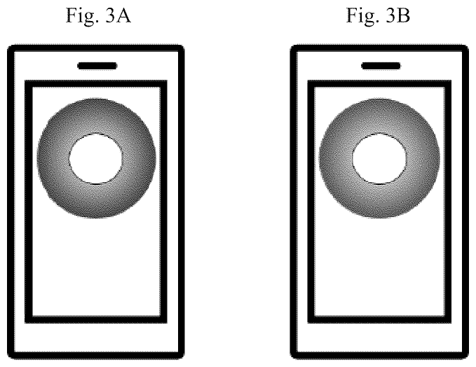

FIGS. 3A-3B show an exemplary simple acceleration response indicator 300. The simple acceleration response indicator 300 may output a Boolean value. On the simple acceleration response indicator 300 this may be represented with a red visual indication for “false” or 0 values, and green for “true” or 1 values. A smoothing function may be used to ensure that the visual indicator does not begin alternating too rapidly, or “strobing”. If a batch of model outputs contains rapidly alternating 0 and 1 values, the smoothing function may show an averaged response when displayed.

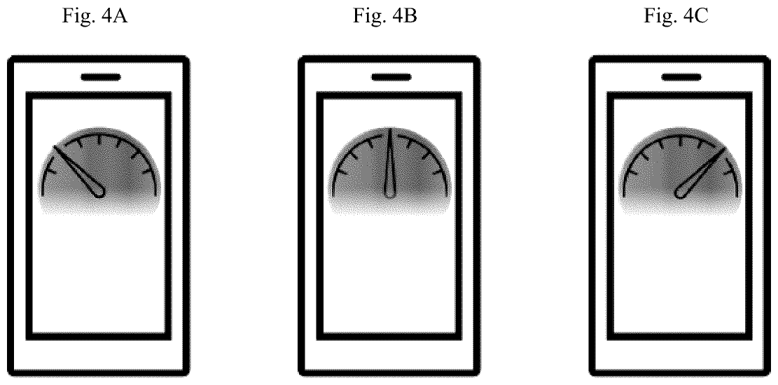

FIGS. 4A-4C show an exemplary refined acceleration response indicator 400. The refined acceleration response indicator 400 may output a number from the continuous range of, for example, 0 to 1. On the refined acceleration response indicator 400 this may be represented by a dial, similar in appearance to a speedometer. The dial point in the center may indicate optimal driving. Overly aggressive driving may move the dial into the red area, informing the driver they should relax their acceleration. Conversely, under accelerating may move the dial into the blue area, indicating the driver can increase their acceleration to further increase their fuel efficiency. It may be understood that in other embodiments any other method of indicating a range with respect to the fuel efficiency of acceleration may be used.

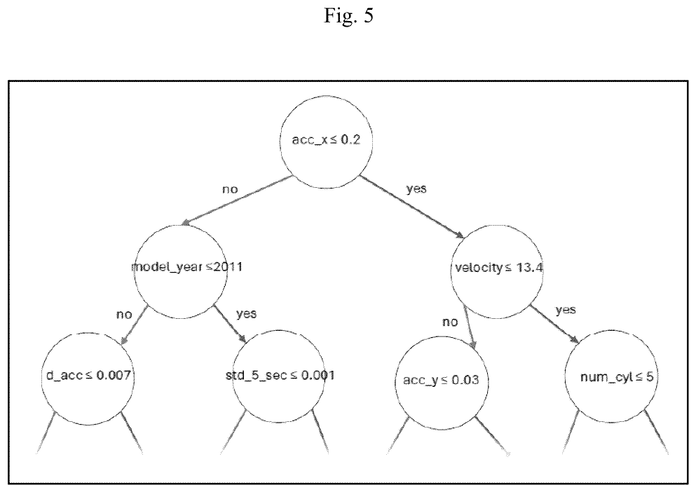

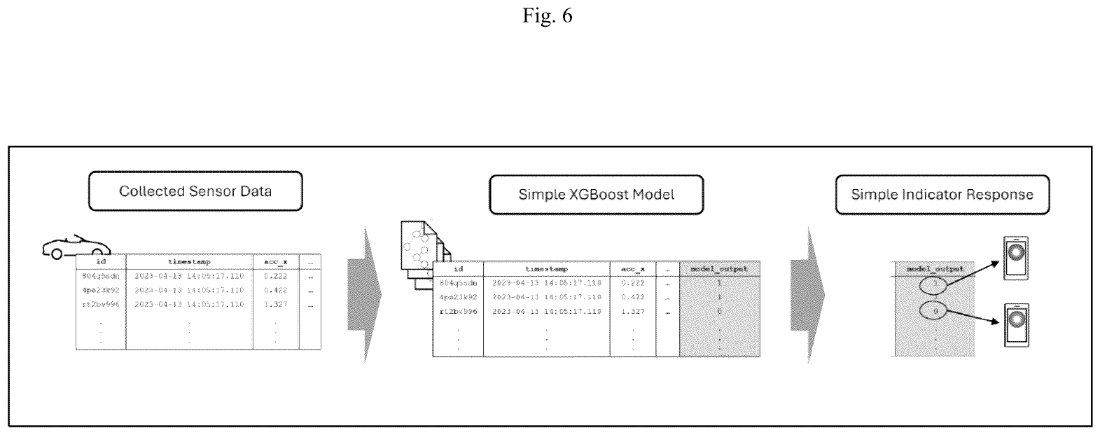

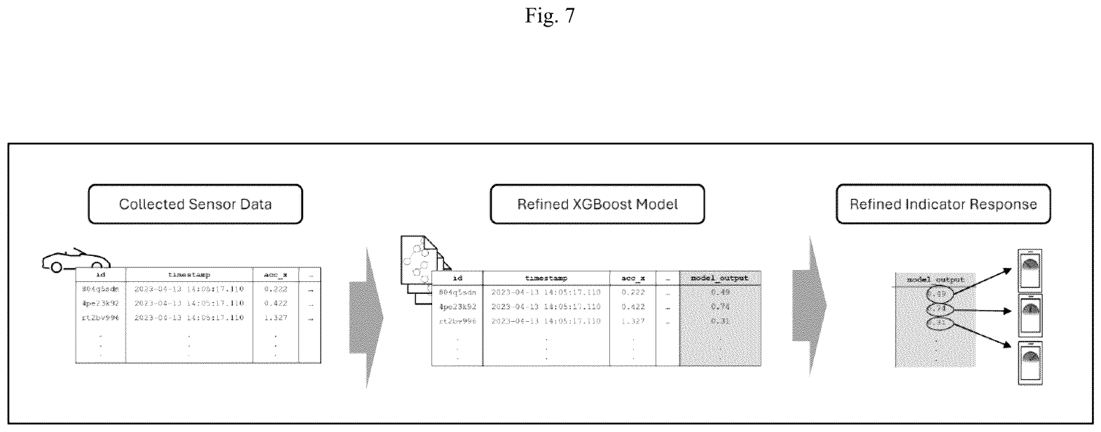

Referring to FIGS. 5-7, the function of the trained models may now be shown and described. The trained models may be developed using a machine learning algorithm, for example in an embodiment using XGBoost. It may be understood that the algorithm may handle large sets of data, be robust against missing values, and be highly configurable during training, testing, and tuning of the model. In an embodiment the algorithm may utilize an ensemble method where multiple decision trees are generated, each attempting to improve on the previous trees' ability to properly classify or predict relative to target data or algorithms the model has been trained on. FIG. 5 may show an exemplary decision tree 500.

A simple model may be generated by utilizing a plurality of data points with a plurality of features. For example, in an embodiment 1 or more million data points may be used and each datapoint may contain a combination of engineered and cleaned mobile sensor data. The data points may include real and/or simulated data, which may be utilized to tune predictive power. In an exemplary embodiment the target variable for the simple model may be a Boolean, which may indicate fair versus poor driving habits. The training data may be collected on a vehicle equipped with an ODB scanner that collects real-time fuel efficiency data. In an exemplary embodiment values below a first threshold value may be mapped to 0 in the training data and indicate a need for corrective action. For example, the first threshold value may be within 30% of peak efficiency. Values within the 30% threshold of peak efficiency may then be mapped to 1 to indicate fair driving and no need for corrective action. It may be understood that in other embodiments other threshold values, or variable threshold values may be used. An exemplary training data mapping algorithm may therefore be, for example,

$${Y}_{s} ( F E ) = \begin{matrix}0 , & F E > 0.7 F {E}_{max} \\ 1 , & F E \leq 0.7 F {E}_{max}\end{matrix}$$

Where FE=Fuel Efficiency, FEₘₐₓ=Maximum Vehicle Fuel Efficiency, and Yₛ(x)=Simple Model Output.

It may be understood that the above algorithm may vary to account for different parameters in different embodiments.

A refined model may be generated by utilizing a plurality of data points with a plurality of features. For example, in an embodiment 1 or more million data points may be used and each datapoint may contain a combination of engineered and cleaned mobile sensor data. In the refined model the data may be additionally enriched via vehicle information, which may be cross-referenced against a vehicle attribute database. Additional vehicle specific features may then be appended to the original plurality of features, which may allow for finer-grain instruction on corrective acceleration habits. The output may be trained so as to be a variable in a continuous range, for example 0 to 1, which corresponds to how optimally the driver is driving, e.g. based on acceleration. An exemplary training data mapping algorithm may therefore be, for example,

$${Y}_{R} ( F E ) ∼ \frac{F E}{F {E}_{max}}$$

Where FE=Fuel Efficiency, FEₘₐₓ=Maximum Vehicle Fuel Efficiency, and Y_{R}(x)=Refined Model Output.

It may be understood that the above algorithm may vary to account for different parameters in different embodiments.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for determining optimal vehicle acceleration comprising:
collecting sensor data of a mobile device within a vehicle;
transmitting the sensor data to a cloud storage;
cleaning the data via a data cleaning API;
engineering additional data features from the sensor data;
appending the additional data features to the sensor data;
sending the engineered features and sensor data to a machine learning (ML) model;
determining, by the ML model, an optimal acceleration for fuel efficiency for the vehicle;
outputting an acceleration indication based on the determined optimal acceleration to the computing device;
displaying the acceleration indication on the computing device.

2. The method of claim 1, wherein the collected sensor data includes at least acceleration data and angular velocity data.

3. The method of claim 2, wherein the optimal acceleration is determined and displayed in substantially real-time.

4. The method of claim 2, wherein the additional data features include velocity, first and second derivatives of acceleration, and first and second derivatives of angular velocity.

5. The method of claim 4, wherein the additional data features further include generating statistical aggregations over one or more predetermined time windows.

6. The method of claim 1, wherein the ML model is hosted on a cloud server.

7. The method of claim 1, wherein the acceleration indication is color coded such that a first color corresponds to an indication to decrease a rate of acceleration of the vehicle and a second color corresponds to an indication to increase.

8. A system for determining optimal vehicle acceleration comprising:
a computing device;
a vehicle;
one or more sensors configured to send sensor data of the mobile device to a cloud storage;
a data processing module configured to clean the data and calculate one or more additional data features from the sensor data, and apply the additional features to the sensor data;
a model prediction module configured to send the sensor data to a machine learning (ML) model, determine by the ML model a level of optimality of current driver acceleration in achieving peak fuel efficiency for the vehicle, and output to the computing device an acceleration indication based on the determined level of optimality of acceleration to the computing device;
wherein the computing device is configured to display the acceleration indication.

9. The system of claim 8, wherein the collected sensor data includes at least acceleration data and angular velocity data.

10. The system of claim 9, wherein the optimal acceleration is determined and displayed in substantially real-time.

11. The system of claim 9, wherein the additional data features include velocity, first and second derivatives of acceleration, and first and second derivatives of angular velocity.

12. The system of claim 11, wherein the additional data features further include generating statistical aggregations over one or more predetermined time windows.

13. The system of claim 8, wherein the ML model is hosted on a cloud server.

14. The system of claim 8, wherein the acceleration indication is color coded such that a first color corresponds to an indication to decrease a rate of acceleration of the vehicle and a second color corresponds to an indication to increase.

15. A non-transitory computer readable medium with computer executable instructions stored thereon executed by a processor to perform a method for determining optimal vehicle acceleration comprising:
collecting sensor data from a mobile computing device;
transmitting the sensor data to a cloud storage;
cleaning the data via a data cleaning API;
engineering additional data features from the sensor data;
appending the additional data features to the sensor data;
sending the engineered features and sensor data to a machine learning (ML) model;
determining, by the ML model, an optimal acceleration for fuel efficiency for the vehicle;
outputting an acceleration indication based on the determined optimal acceleration to the computing device;
displaying the acceleration indication on the computing device.
